(19) United States
(12) Patent Application Publication
(10) Pub. No.: US 2026/0016958 A1
(43) Pub. Date: Jan. 15, 2026

(54) MEMORY IN PACKAGE DEVICES AND ASSOCIATED SYSTEMS AND METHODS

(71) Applicant: Micron Technology, Inc., Boise, ID (US)

(72) Inventor: Sujeet Ayyapureddi, Boise, ID (US)

(21) Appl. No.: 19/261,816

(22) Filed: Jul. 7, 2025

Related U.S. Application Data
(60) Provisional application No. 63/669,076, filed on Jul. 9, 2024.

(51) Int. Cl. G06F 3/06

(52) U.S. Cl. CPC G06F 3/061; G06F 3/0655; G06F 3/0673

(57) ABSTRACT

Memory-in-package (MiP) devices and associated systems and methods are disclosed. A MiP device includes a base substrate and one or more HBM devices configured with data pass-through features. Each of the HBM devices includes an interface die including first and second input/output (IO) circuits and first and second sets of pass-through logic. The first and second sets of pass-through logic are configured to pass data from the first IO circuit to the second IO circuit, or from the second IO circuit to the first IO circuit. The interface die determines, via the first and second sets of pass-through logic, where to steer data received at the first and second IO circuits based on the address of the data and an address scheme. The first and second IO circuits are configured to communicably couple the HBM devices to each other such that the HBM devices form a data pathway chain.

### CROSS-REFERENCE TO RELATED APPLICATION(S)

The present application claims priority to U.S. Provisional Patent Application No. 63/669,076, filed Jul. 9, 2024, the disclosure of which is incorporated herein by reference in its entirety.

### TECHNICAL FIELD

The present technology is generally related to vertically stacked semiconductor memory devices, and more specifically to systems and methods for multiple interconnected high-bandwidth memory devices with data pass-through features.

### BACKGROUND

An electronic apparatus (e.g., a processor, a memory device, a memory system, or a combination thereof) can include one or more semiconductor circuits configured to store and/or process information. For example, the apparatus can include a memory device, such as a volatile memory device, a non-volatile memory device, or a combination device. Memory devices, such as dynamic random-access memory (DRAM) and/or high-bandwidth memory (HBM), can utilize electrical energy to store and access data.

With technological advancements in embedded systems and increasing applications, the market is continuously looking for faster, more efficient, and smaller devices. To meet market demands, semiconductor devices are being pushed to the limit with various improvements. Improving devices, generally, may include increasing circuit density, increasing circuit capacity, increasing operating speeds (or otherwise reducing operational latency), increasing reliability, increasing data retention, reducing power consumption, or reducing manufacturing costs, among other metrics. Attempts, however, to meet market demands, such as increasing circuit capacity, can often introduce challenges in other aspects, such as excessive costs and limited scaling options.

### BRIEF DESCRIPTION OF THE DRAWINGS

FIG. 1 is a partially schematic cross-sectional diagram of a system-in-package device.

FIG. 2A is a partially schematic cross-sectional diagram of a High-Bandwidth Memory device with data pass-through configured in accordance with some embodiments of the present technology.

FIG. 2B is a partially schematic top-down view of a High-Bandwidth Memory device with data pass-through configured in accordance with some embodiments of the present technology.

FIG. 3 is a partially schematic cross-sectional diagram of a memory-in-package device configured in accordance with some embodiments of the present technology.

FIG. 4 is a partially schematic top-down view of a memory-in-package device communicably coupled to multiple system-in-package devices, in accordance with some embodiments of the present technology.

FIG. 5 is a flow diagram of a process for manufacturing a memory-in-package device in accordance with some embodiments of the present technology.

The drawings have not necessarily been drawn to scale. Similarly, some components and/or operations can be separated into different blocks or combined into a single block for the purpose of discussion of some of the implementations of the present technology. Moreover, while the technology is amenable to various modifications and alternative forms, specific implementations have been shown by way of example in the drawings and are described in detail below. The intention, however, is not to limit the technology to the particular implementations described.

### DETAILED DESCRIPTION

High data reliability, high speed of memory access, lower power consumption, and reduced chip size are features that are demanded from semiconductor memory. In recent years, vertically stacked memory devices have been introduced, often referred to as 2.5-dimensional (“2.5D”) memory devices when placed adjacent to a host device. Some 2.5D memory devices are formed by stacking memory dies vertically, and interconnecting the dies using through-silicon (or through-substrate) vias (TSVs). Benefits of the 2.5D memory devices include shorter interconnects (which reduce circuit delays and power consumption), a large number of vertical vias between layers (which allow wide bandwidth buses between functional blocks, such as memory dies, in different layers), and a considerably smaller footprint. Thus, the 2.5D memory devices contribute to higher memory access speed, lower power consumption, and chip size reduction. Example 2.5D memory devices include Hybrid Memory Cube (HMC) and High-Bandwidth Memory (HBM) devices. For example, HBM devices are a type of memory that includes a vertical stack of dynamic random-access memory (DRAM) dies and an interface die (which, e.g., provides the interface between the DRAM dies of the HBM device and a host device). As a further example, HBM devices can include a combination of different volatile and/or non-volatile memory types.

In a system-in-package (SiP) configuration, HBM devices may be integrated with host devices (e.g., one or more graphics processing units (GPUs), computer processing units (CPUs), tensor processing units (TCUs), and/or any other suitable processing units) using a base substrate (e.g., a silicon interposer, a substrate of organic material, a substrate of inorganic material and/or any other suitable material that provides interconnection between the host device and the HBM device and/or provides mechanical support for the components of a SiP device), through which the HBM devices and hosts communicate. Because traffic between the HBM devices and host devices resides within the SiP (e.g., using signals routed through the silicon interposer), a higher bandwidth may be achieved between the HBM devices and host devices than in conventional systems. In other words, the TSVs interconnecting DRAM dies within an HBM device, and the silicon interposer integrating HBM devices and host devices, enable the routing of a greater number of signals (e.g., wider data buses) than is typically found between packaged memory devices and a host device (e.g., through a printed circuit board (PCB)). The high-bandwidth interface within a SiP enables large amounts of data to move quickly between the host devices (e.g., GPUs/CPUs/TCUs) and HBM devices during operation. For example, the high-bandwidth channels can be on the order of 1000 gigabytes per second (GB/s, sometimes also referred to as gigabits (Gb)). As a result, the SiP device can quickly complete computing operations once data is loaded into the HBM devices. SiP devices, in turn, are typically integrated with a package substrate (e.g., a PCB) adjacent to other electronics and/or other SiP devices within a packaged system.

Market demands on SiP devices and/or the HBM devices therein can present certain challenges, however. One such challenge is that demands on SiP devices (and the HBM devices therein) require the devices to have access to much greater memory capacities than traditionally available. One approach to increasing capacity is to increase the number of DRAM dies comprising the vertical stack of the HBM device. However, adding dies is often expensive, and the vertical stack height of SiP devices (including HBM devices) is often space-limited. The systems and methods described herein address these and other challenges posed by ever-growing capacity demands with a “Memory in Package” (MiP) device comprised of multiple HBM devices configured with data pass-through features that allow data to pass between and through the multiple HBM devices. An HBM device with data pass-through is comprised of an interface die with multiple input/output (IO) circuits, and is configured to pass data from and/or between each of the IO circuits (e.g., via pass-through logic, one or more multiplexers and/or demultiplexers, etc.). For example, a MiP can be comprised of first, second, and third HBM devices, each configured with data pass-through. The first HBM device can be connected to the second HBM device via a first IO circuit of the second HBM device, and the third HBM device can be connected to the second HBM device via a second IO circuit of the second HBM device. The second HBM device can receive a data request via the first IO circuit from the first HBM device with an address associated with the third HBM device. The second HBM device can be configured to pass the data request (via pass-through logic of an interface die, discussed more below) from the first IO circuit to the second IO circuit, and then pass the data request to the third HBM device via the second IO circuit. As described herein, the MiP and HBM devices with pass-through can greatly increase the memory capacity available to host devices without the expense and technical challenge of increasing HBM device size (e.g., in the vertical dimension).

As used herein, the terms “vertical,” “lateral,” “upper,” “lower,” “top,” and “bottom” can refer to relative directions or positions of features in the devices in view of the orientation shown in the drawings. For example, “bottom” can refer to a feature positioned closer to the bottom of a page than another feature. These terms, however, should be construed broadly to include devices having other orientations, such as inverted or inclined orientations where top/bottom, over/under, above/below, up/down, and left/right can be interchanged depending on the orientation.

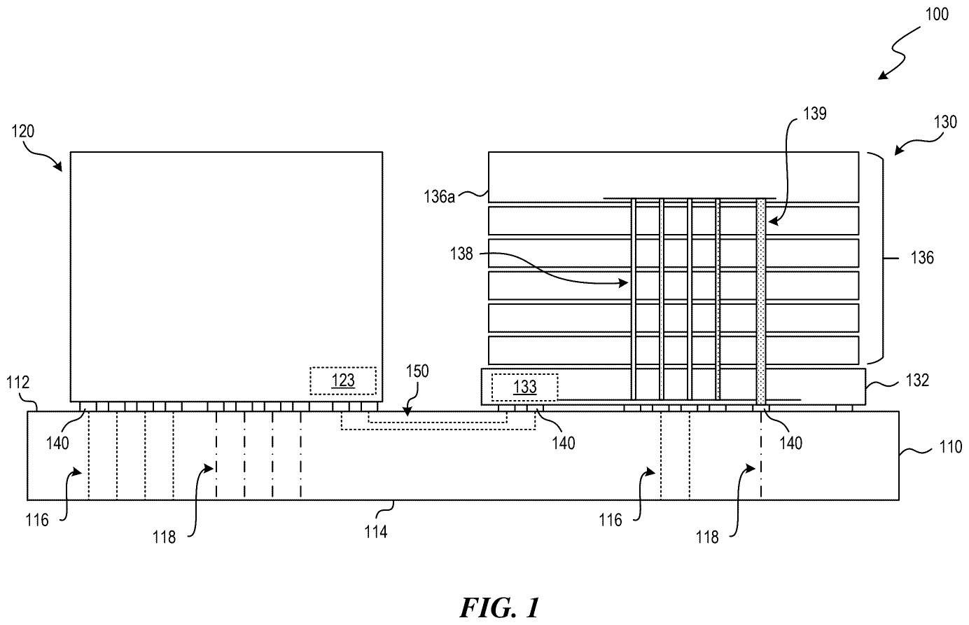

FIG. 1 is a partially schematic cross-sectional diagram of a system-in-package (SiP) device 100. As illustrated in FIG. 1, the SiP device 100 includes a base substrate 110 (e.g., a silicon interposer, another organic interposer, an inorganic interposer, and/or any other suitable base substrate), as well as a host device 120 and an HBM device 130 each integrated with (e.g., carried by and coupled to) an upper surface 112 of the base substrate 110 through a plurality of interconnect structures 140 (three labeled in FIG. 1). The interconnect structures 140 can be solder structures (e.g., solder balls), metal-metal bonds, and/or any other suitable conductive structure that mechanically and electrically couples the base substrate 110 to each of the host device 120 and the HBM device 130. Further, the host device 120 is coupled to the HBM device 130 through one or more communication channels 150 formed in the base substrate 110 (sometimes referred to as a SiP bus). The communication channels 150 can include one or more route lines (two illustrated schematically in FIG. 1) formed into (or on) the base substrate 110.

As further illustrated in FIG. 1, the base substrate 110 includes a plurality of external signal TSVs 116 and a plurality of external power TSVs 118 extending between the upper surface 112 and a lower surface 114 of the base substrate 110. The external signal TSVs 116 can communicate signals (e.g., data, control signals, processing commands, and/or the like) between the host device 120 and/or the HBM device 130 and an external component (e.g., a PCB the base substrate 110 is integrated with, an external controller, and/or the like). The external power TSVs 118 provide electrical power to the host device 120 and/or the HBM device 130 from an external power source.

The host device 120 can include a variety of components, such as a processing unit (e.g., CPU/GPU/TCU), one or more registers, one or more cache memories, and/or a variety of other components. For example, in the illustrated environment, the host device 120 includes a host IO circuit 123 that can direct signals to and/or from the HBM device 130 through the communication channels 150. Additionally, or alternatively, the host IO circuit 123 can direct signals to and/or from an external component (e.g., a controller coupled to one or more of the external signal TSVs 116 and/or the like).

The HBM device 130 can include an interface die 132 and a stack of one or more memory dies 136 (six illustrated in FIG. 1) carried by the interface die 132. The HBM device 130 also includes one or more signal TSVs 138 (four illustrated in FIG. 1) and one or more power TSVs 139 (one illustrated in FIG. 1) each extending from the interface die 132 to an uppermost memory die 136a. The power TSV(s) 139 provide power (e.g., received from one or more of the external power TSVs 118) to the interface die 132 and each of the memory dies 136. The signal TSVs 138 communicably couple each of the memory dies 136 to an IO circuit 133 in the interface die 132 (in addition to various other circuits in the interface die 132). In turn, the IO circuit 133 can direct signals to and/or from the host device 120 and/or an external component (e.g., an external storage device coupled to one or more of the external signal TSVs 116 and/or the like). As illustrated in FIG. 1, the HBM device 130 includes a single IO circuit 133 disposed on a single side of the interface die 132. In further examples provided below, multiple IO circuits can be disposed on multiple sides of the interface die 132.

MiP devices and related systems and methods that address the shortcomings discussed above are disclosed herein. For example, as discussed in more detail below, a MiP device according to the present technology can include a base substrate, as well a one or more HBM devices configured with data pass-through (also referred to “HBM devices”), each of which is integrated with the base substrate. Each of the HBM devices includes a stack of one or more memory dies, first and second pluralities of TSVs, and an interface die. The interface dies of one or more of the HBM devices include first and second IO circuits and first and second sets of pass-through logic. The first and second IO circuits are configured to communicably couple one or more of the HBM devices of the MiP device to one or more host devices (e.g., a SiP including a processor, a GPU, etc.). The first and second IO circuits are further configured to communicably couple the HBM devices to each other such that the HBM devices form a “chain.” That is, multiple HBM devices of the MiP can be communicably coupled in series and be configured to pass data to and receive data from adjacent HBM devices in the chain. For example, a first HBM device can be communicably coupled to a second HBM device “upstream” the chain via a first IO circuit, and communicably coupled to a third HBM device “downstream” the chain via a second IO circuit. As used in this context, “upstream” and “downstream” refer to relative position in a chain of HBM devices communicably coupled to a host device, with HBM devices more distant in the chain from the host device being downstream from HBM devices more proximate in the chain to the host device. The interface die of each HBM device determines via the first and second sets of pass-through logic where to steer data based on the address of the data and the address scheme of the MiP. Thus, as is discussed further below, a data request addressed to a target HBM device originating from a device communicably connected to the MiP (e.g., a host device disposed on the MiP or a communicably coupled SiP) can be transmitted along the chain of HBM devices of the MiP until received by the target HBM device. In some embodiments, one or more of the IO circuits can be configured to operate according to a JEDEC HBM DRAM standard. In some embodiments, one or more of the IO circuits can be configured to operate according to a short reach interface standard, such as Universal Chiplet Interconnect Express (UCIe) or Peripheral Component Interconnect Express (PCIe). In some embodiments, one or more of the IO circuits of an interface die of an HBM device of the MiP are communicably coupled to a host device (disposed on the MiP or a communicably coupled SiP).

The first and second IO circuits are further configured to pass data to the first and second pluralities of TSVs. The first and second pluralities of TSVs extend through the memory dies and couple to the first and second IO circuits of the interface die, respectively. For example, a first plurality of TSVs can extend through the memory dies and couple to a first IO circuit of an interface die, and a second plurality of TSVs can extend through the memory dies and couple to a second IO circuit of the interface die. The first plurality of TSVs coupled to the first IO circuit can be used to respond to data requests and access memory of the HBM device independently and/or concurrently from the second plurality of TSVs coupled to the second IO circuit, and vice versa. As a result, multiple host devices (e.g., a first SiP and a second SiP) can access the memory of the HBM device concurrently. In some embodiments, the memory of the HBM device is partitioned such that the first plurality of TSVs is communicably coupled to a first partition of memory, and the second plurality of TSVs is communicatively coupled to a second partition of memory. In said embodiments, a first host device can access a first memory partition, and a second host device can access a second memory partition. In some embodiments, the first and second memory partitions are non-overlapping. In some embodiments, the memory of the HBM device can be partitioned by bank, bank group, or pseudo channel.

The interface die is configured to steer data to the memory of the HBM device (e.g., the first or second memory banks) or to transmit the data to further HBM devices (e.g., along the chain) of the MiP, based on the address of the data and the address scheme of the MiP. For example, if a first IO circuit of a first HBM device receives data addressed to the first memory partition, the interface die can steer the data to the first memory partition via a first plurality of TSVs. If the first IO circuit receives data addressed to the second memory partition, the interface die can steer the data to the second memory partition via a first set of pass-through logic, a second IO circuit, and a second plurality of TSVs. If the first IO circuit receives data addressed to an HBM device other than the first HBM device, the interface die can steer the data to a subsequent HBM device (e.g., a second HBM device) in the chain of HBM devices of the MiP via the first set of pass-through logic and the second IO circuit. Similarly, the interface die can steer data received by the second IO circuit to (i) the second memory partition via the second plurality of TSVs, (ii) the first memory partition via a second set of control logic, the first IO circuit, and the first plurality of TSVs, and/or (iii) a subsequent HBM device (e.g., a third HBM device) via the second set of control logic and the first IO circuit.

In some embodiments, the MiP utilizes a global address scheme, where each of the HBM devices of the MiP is associated with a respective range of non-overlapping addresses. For example, a first HBM device can have addresses [0 . . . x], a second HBM device can have addresses [x+1 . . . y], a third HBM device can have addresses [y+1 . . . z], etc. In some embodiments, each of the memory partitions of each of the HBM devices is associated with a respective range of addresses (e.g., non-overlapping subsets of the range of the respective HBM device as a whole). For example, if the interface die of the first HBM device receives a data request (e.g., at a first IO circuit) with an associated address that is in the address range of the first HBM device, the interface die will determine if the address is associated with the first or second memory partition of the first HBM device, and pass the data request to the associated memory partition. If the interface die receives a data request with an associated address that is not within the address range of the first HBM device, the interface die will pass the data request from the first IO circuit to the second IO circuit via the first set of pass-through logic, and from the second IO circuit to a subsequent HBM device in the chain (e.g., a second HBM device).

In some embodiments, a first HBM device (for example, an interface die therein) is configured to modify an address associated with a data request prior to transmitting the data request to a second HBM device. For example, each of the HBM devices can have a given memory capacity. An interface die of a first HBM device can receive a data request associated with an address, where the address is associated with a memory location that exceeds (e.g., is greater than) the memory capacity of the first HBM device. The interface die can subtract the memory capacity of the HBM device from the address to produce a modified address, and pass on the data request with the modified address to a second HBM device. An interface die of the second HBM device can then receive the data request with the modified address (e.g., reduced by the memory capacity of the first HBM device). If the modified address is associated with a memory location that is within the memory capacity of the second HBM device, interface die of the second HBM device determines that the second HBM device is the destination or target of the data request. In some embodiments, the interface die of the second HBM device passes the associated data request to the first memory partition if the memory request is within the capacity of the first memory partition (via a first IO circuit and first plurality of TSVs), and passes the associated data request to the second memory partition (e.g., via a first set of pass-through logic, second IO circuit, and second plurality of TSVs) if the memory request exceeds the capacity of the first memory partition. If the modified address is associated with a memory location that exceeds (e.g., is greater than) the memory capacity of the second HBM device, then the interface die of the second HBM device subtracts the memory capacity of the second HBM device from the modified address and passes the data to the next HBM device in the chain (e.g., a third HBM device).

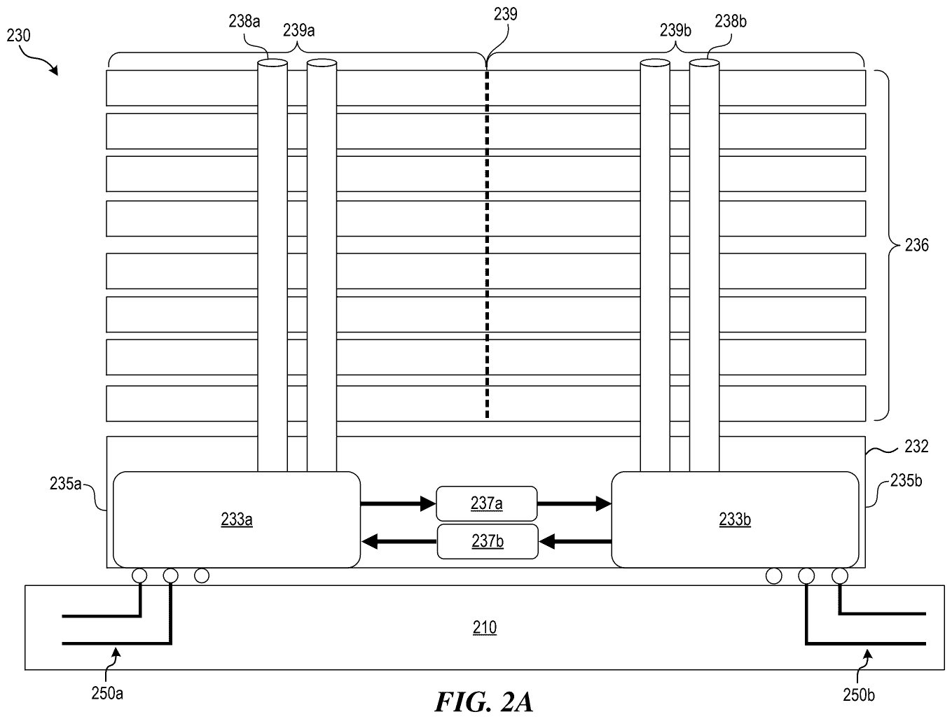

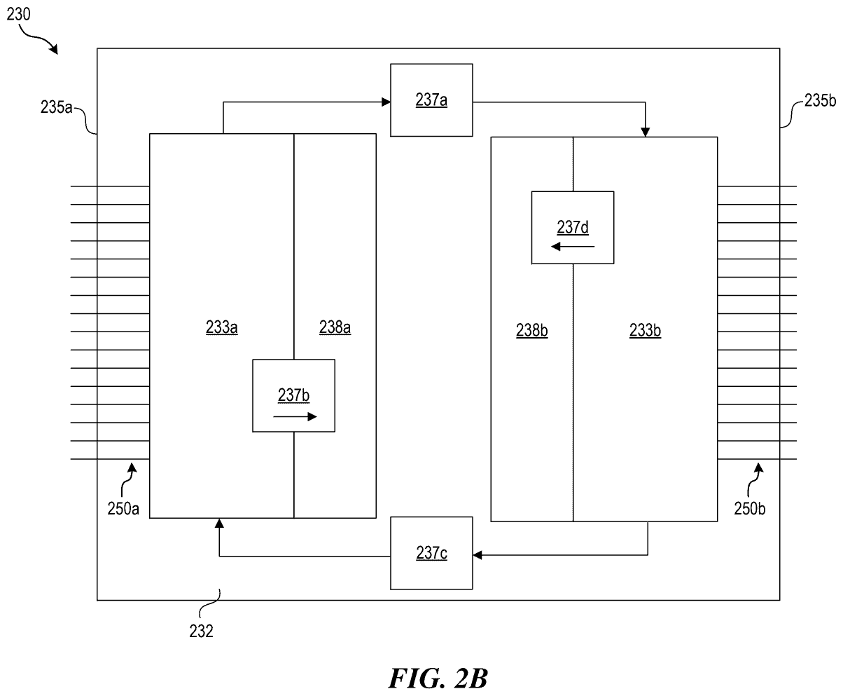

Additional details on the MiP device, HBM devices with data pass-through, components thereof, and related systems and methods are discussed below with reference to FIGS. 2A-5.

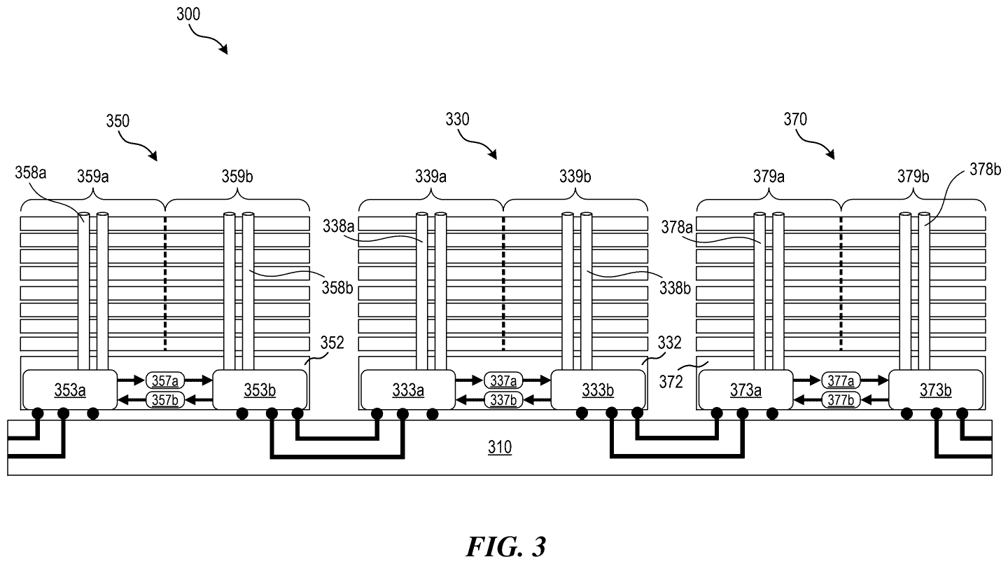

FIG. 2A is a partially schematic cross-sectional diagram of a High-Bandwidth Memory (HBM) device 230 with data pass-through configured in accordance with some embodiments of the present technology. In some embodiments, the HBM device 230 includes similar components and features as the HBM device 130 of FIG. 1. The HBM device is configured to be carried by a base substrate 210 (e.g., a silicon interposer). The HBM device 230 includes one or more memory dies 236 carried by an interface die 232. The interface die 232 includes multiple IO circuits, such as a first IO circuit 233a and a second IO circuit 233b. The first and second IO circuits 233a, 233b are configured to communicably couple HBM device 230 to additional HBM devices (discussed further with regard to FIG. 3) via communication channels 250a, 250b formed in the base substrate 210. In some embodiments, the at least one of the first and second IO circuits 233a, 233b, is configured to communicably couple HBM device 230 to a host device (e.g., a SiP including a processor, a GPU, etc.). In some embodiments, the first IO circuit 233a is disposed on a first side 235a of the interface die 232, and the second IO circuit 233b is disposed on a second side 235b of the interface die 232.

In some embodiments, the HBM device 230 includes one or more pluralities of TSVs. For example, FIG. 2A shows a first plurality of TSVs 238a and a second plurality of TSVs 238b. In the present example, the first plurality of TSVs 238a is configured to communicably couple the one or more memory dies 236 to the first IO circuit 233a and the second plurality of TSVs 238b is configured to communicably couple the memory dies 236 to the second IO circuit 233b.

In some embodiments, the memory of the HBM device 230 is partitioned (represented by a dashed line 239) such that the HBM device 230 is comprised of a first memory partition 239a and a second memory partition 239b. In the present example, the first memory partition 239a is communicably coupled to the interface die 232 via the first IO circuit 233a and the first plurality of TSVs 238a. The second memory partition 239b is communicably coupled to the interface die 232 via the second IO circuit 233b and the second plurality of TSVs 238b. In some embodiments, the first memory partition 239a is accessible via the first IO circuit 233a and first plurality of TSVs 238a independently of the second memory partition 239b via the second IO circuit 233b and second plurality of TSVs 238b. For example, a first data request originating from a first host device can access the first memory partition 239a, while a second data request originating from a second host device can independently access the second memory partition 239b. In some embodiments, the memory of the HBM device 230 is partitioned by memory bank. In some embodiments, the memory of the HBM device 230 is partitioned by bank group. In some embodiments, the memory of the HBM device 230 is partitioned by pseudo channel.

The interface die 232 is configured to steer (e.g., direct) incoming data (e.g., memory requests, responses to memory requests including data, etc.) received from the first and second IO circuits 233a, 233b to a correct data pathway. The interface die 232 includes control logic that determines the correct data pathway based at least in part on address information of the incoming data and an address scheme (discussed further in FIG. 3). For example, the interface die 232 includes control logic comprised at least in part of a first set of pass-through logic 237a configured to pass data received by the first IO circuit 233a to the second IO circuit 233b when the address of the data corresponds to the second memory partition 239b, or when the address of the data corresponds to a second HBM device communicably coupled (directly and/or indirectly via other HBM devices) to the IO circuit 233b. The interface die 232 further includes a second set of pass-through logic 237b configured to pass data received by the second IO circuit 233b to the first IO circuit 233a when the address of the data corresponds to the first memory partition 239a, or when the address of the data corresponds to a third HBM device communicably coupled (directly and/or indirectly via other HBM devices) to the IO circuit 233a. In some embodiments the second HBM device is a downstream HBM device and/or the third HBM device is an upstream HBM device. The interface die 232 further includes control logic configured to pass data received by the first IO circuit 233a to the first plurality of TSVs 238a when the address of the data corresponds to the first memory partition 239a, and control logic configured to pass data received by the second IO circuit 233b to the second plurality of TSVs 238b when the address of the data corresponds to the second memory partition 239b. It will be appreciated that although FIG. 2A illustrates embodiments in which the first and second sets of pass-through logic 237a, 237b are separate from the first and second IO circuits 233a, 233b, in some embodiments aspects of the first and second sets of pass-through logic 237a, 237b are implemented as part of the first and second IO circuits 233a, 233b.

FIG. 2B is a partially schematic top-down view of an HBM device 230 with data pass-through configured in accordance with some embodiments of the present technology. In the present example, HBM device 230 includes an interface die 232 configured with at least four sets of pass-through logic 237a-d. If HBM device 230 receives a data request at the first IO circuit 233a (e.g., from an upstream or second HBM device, and/or from a set of pass-through logic), the interface die 232 is configured to: (i) pass the data request to the second IO circuit 233b via a first set of pass-through logic 237a if the address corresponding with the data request correlates either with a second memory partition of the HBM device 230 accessible from the second plurality of TSVs 238b or a downstream HBM device, or (ii) pass the data request to the first plurality of TSVs 238a via a second set of pass-through logic 237b if the address corresponding with the data request correlates with a first memory partition of the HBM device 230 accessible from the first plurality of TSVs 238a. If HBM device 230 receives a data request at the second IO circuit 233b (e.g., from a downstream or third HBM device, and/or from a set of pass-through logic), the interface die 232 is configured to: (i) pass the data request to the first IO circuit 233a via a third set of pass-through logic 237c if the address corresponding with the data request correlates with either the first memory partition of the HBM device 230 or an upstream HBM device, or (ii) pass the data request to the second plurality of TSVs 238b via a fourth set of pass-through logic 237d if the address corresponding with the data request correlates with the second memory partition of the HBM device 230.

In some embodiments, the first and second IO circuits 233a, 233b are configured to operate according to a JEDEC HBM DRAM standard. In some embodiments, the first and second IO circuits 233a, 233b are configured to operate according to a short reach interface standard, such as Universal Chiplet Interconnect Express (UCIe) or Peripheral Component Interconnect Express (PCIe).

FIG. 3 is a partially schematic cross-sectional diagram of a memory-in-package (MiP) device 300 configured in accordance with some embodiments of the present technology. MiP device 300 is comprised of multiple HBM devices configured with data pass-through, each carried by a common base substrate 310. In the present example, MiP device 300 is comprised at least of a first HBM device 330 with data pass-through, a second HBM device 350 with data pass-through, and a third HBM device 370 with data pass-through. In some embodiments, the first, second, and third HBM devices 330, 350, 370 include similar components and features as the HBM device 130 of FIG. 1 and/or the HBM device 230 of FIGS. 2A-2B.

The first HBM device 330 is communicably coupled to the second HBM device 350 via a first IO circuit 333a of the first HBM device 330 and a second IO circuit 353b of the second HBM device 350. The first HBM device 330 is communicably coupled the third HBM device 370 via a second IO circuit 333b of the first HBM device 330 and a first IO circuit 373a of the third HBM device 370. The first HBM device 330 includes first and second memory partitions 339a, 339b communicably coupled to the first and second IO circuits 333a, 333b via first and second pluralities of TSVs 338a, 338b, and further includes an interface die 332. The interface die 332 includes a first set of pass-through logic 337a configured to pass data from the first IO circuit 333a to the second IO circuit 333b, and a second set of pass-through logic 337b configured to pass data from the second IO circuit 333b to the first IO circuit 333a. The second HBM device 350 includes first and second memory partitions 359a, 359b communicably coupled to first and second IO circuits 353a, 353b via first and second pluralities of TSVs 358a, 358b, and further includes an interface die 352 comprising first and second sets of pass-through logic 357a, 357b. The third HBM device 370 includes first and second memory partitions 379a, 379b communicably coupled to first and second IO circuits 373a, 373b via first and second pluralities of TSVs 378a, 378b, and further includes an interface die 372 comprising first and second sets of pass-through logic 377a, 377b.

The interface die of each of the first, second, and third HBM devices 330, 350, and 370 are configured to steer data received by the respective HBM devices to a correct data pathway and/or location corresponding to an address of the data. For example, the second HBM device 350 can transmit a data request with an address corresponding with the second memory partition 379b of the third HBM device 370 via the first HBM device 330. In such an example, the second IO circuit 353b of the second HBM device 350 transmits the data request to the first IO circuit 333a of the first HBM device 330. The interface die 332 of the first HBM device 330 determines that the address of the data request does not correlate with an address of the first HBM device 330. The interface die 332 passes the data request to the second IO circuit 333b via the first pass-through logic 337a. The second IO circuit 333b passes the data request to the first IO circuit 373a of the third HBM device 370. The interface die 372 of the third HBM device 370 determines that the address of the data request corresponds with the third HBM device 370. In some embodiments, the interface die 372 further determines that the address corresponds with a particular memory partition (e.g., the second memory partition 379b) of the third HBM device 370. The interface die 372 passes the data request to the second IO circuit 373b via the first set of pass-through logic 377a. The second IO circuit 373b passes the data request to the second memory partition 379b via the second plurality of TSVs 378b.

In some embodiments, each of the interface die in a data pathway (e.g., interface die 352, 332, and 372 of the present example) determines the correct data pathway based at least in part on address information of the data and an address scheme of the MiP device 300. In some embodiments, the MiP device 300 includes a global address scheme, where each of the HBM devices 330, 350, and 370 are associated with a respective range of non-overlapping addresses. For example, as discussed above, if the interface die 332 of the first HBM device 330 receives a data request (e.g., at a first IO circuit 333a) with an associated address in an address range of the first HBM device 330, the interface die 332 steers the data request to a memory location corresponding to the address (e.g., the interface die 332 steers the data request to the first or second memory partitions 339a, 339b). If the interface die 332 of the first HBM device 330 receives a data request with an associated address that is not in the address range of the first HBM device 330, the interface die 332 passes the data request to a subsequent HBM device in the HBM chain (e.g., the third HBM device 370 via the first set of pass-through logic 337a and second IO circuit 333b).

As another example, if the interface die 332 of the first HBM device 330 receives a data request (e.g., at a first IO circuit 333a) with an associated address that is below an address range of the first HBM device 330 (e.g., the second HBM device 350), the interface die 332 can be configured to not pass the data request on. If the interface die 332 receives a data request with an associated address that is in the address range of the first HBM device 330, the interface die will determine if the address is associated with the first or second memory partitions 339a, 339b, and pass the data request to the associated memory partition (e.g., via the first plurality of TSVs 338a, or via the first set of pass-through logic 337a, second IO circuit 333b, and second plurality of TSVs 338b). If the interface die 332 receives a data request with an associated address that is above the address range of the first HBM device 330 (e.g., the third HBM device 370), the interface die 332 will pass the data request from the first IO circuit 333a to the second IO circuit 333b via the first set of pass-through logic 337a, and from the second IO circuit 333b to a subsequent HBM device in the chain (e.g., the third HBM device 370).

In some embodiments, one or more of the interface die in a data pathway (e.g., interface die 352, 332, and 372 of the present example) are configured to modify an address associated with a data request prior to transmitting the data request (e.g., in accordance with a local address scheme). For example, each of the first, second, and third HBM devices 330, 350, and 370 can have a given memory capacity. The interface die 332 of the first HBM device 330 can receive a data request with an associated address, where the address is associated with a memory location that exceeds (e.g., is greater than) the memory capacity of the first HBM device 330. The interface die 332 can subtract the memory capacity of the HBM device 330 from the address to produce a modified address, and pass on the data request with the modified address to a subsequent HBM device (e.g., the third HBM device 370). The interface die 372 of the third HBM device 370 can then receive the data request with the modified address (e.g., reduced by the memory capacity of the first HBM device 330). If the modified address is within the memory capacity of the third HBM device 370, the interface die 372 passes the associated data request to the first memory partition 379a if the memory request is within the capacity of the first memory partition 379a (via a first IO circuit 373a and first plurality of TSVs 378a), and passes the associated data request to the second memory partition 379b (e.g., via a first set of pass-through logic 377a, second IO circuit 373b, and second plurality of TSVs 378b) if the memory request exceeds the capacity of the first memory partition 379a. If the modified address is associated with a memory location that exceeds (e.g., is greater than) the memory capacity of the third HBM device 370, then the interface die 372 subtracts the memory capacity of third HBM device 370 from the modified address and passes the data to the next HBM device in the chain (e.g., a fourth HBM device of the MiP device 300).

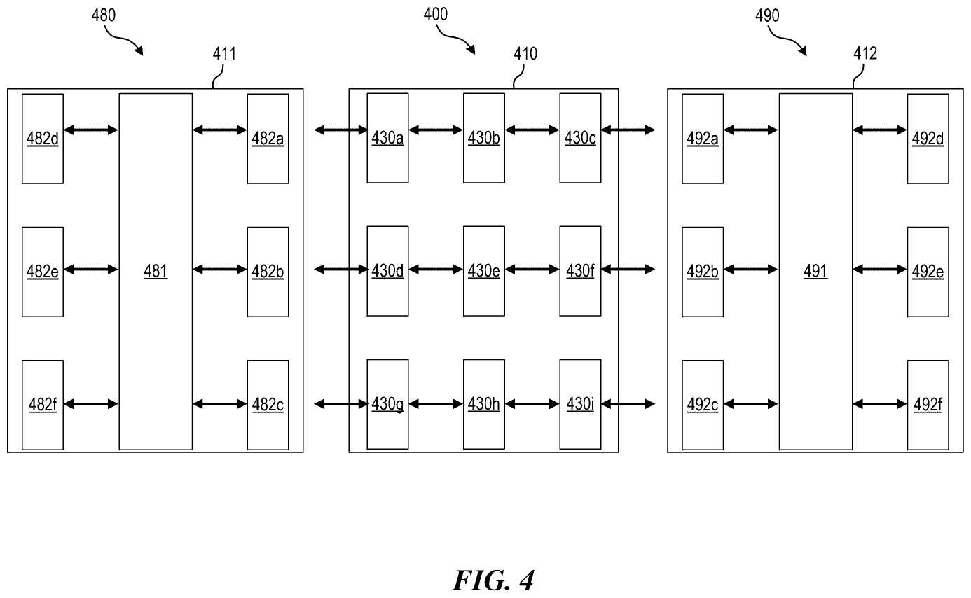

FIG. 4 is a partially schematic top-down view of a MiP device 400 communicably coupled to multiple SiP devices, in accordance with some embodiments of the present technology. In some embodiments, MiP device 400 is comprised of multiple HBM devices 430a-i configured with data pass-through, each carried by a common base substrate 410. In some embodiments, each of the HBM devices of MiP device 400 include similar components and features as the HBM device 130 of FIG. 1, the HBM device 230 of FIGS. 2A-2B, and/or the HBM devices 330, 350, 370 of FIG. 3.

In the present example, MiP device 400 is communicably coupled with a first SiP device 480 and a second SiP device 490. The first SiP device 480 is comprised of a host device 481 (e.g., a processor, GPU, etc.), and one or more HBM devices 482a-f. The HBM devices 482a-f can be configured with data pass-through, or can be conventional HBM devices. The second SiP device 490 is comprised of a host device 491 and one or more HBM devices 492a-f that can be configured with data pass-through or can be conventional HBM devices.

A data request originating at host device 481 can be transmitted to any of the interconnected HBM devices 430a-i, as described above. Similarly a data request originating at host device 491 can be transmitted via the chain of HBM devices 430a-i to any of the interconnected HBM devices 430a-i. For example, host device 481 can originate a first data request with an associated address corresponding to HBM device 430c. The first data request is passed from host device 481 to HBM device 430c of the MiP device 400 via HBM device 482a (of the first SiP device 480), HBM device 430a, and HBM device 430b. Simultaneously, host device 491 can originate a second data request with an associated address corresponding to HBM device 430e. The second data request is passed from host device 491 to HBM device 430e of the MiP device 400 via HBM device 492b (of the second SiP device 490), and HBM device 430f. In some embodiments, the MiP device 400, the first SiP device 480, and the second SiP device 490 are all carried by a single common base substrate (not shown). In some embodiments, the MiP device 400, first SiP device 480, and second SiP device 490 are each carried by separate base substrates (e.g., a first base substrate 410, a second base substrate 411, and a third base substrate 412). In such embodiments, additional substrates (e.g., first and second interposers, not shown) can communicably couple MiP device 400, the first SiP device 480 and the second SiP device 490. For example, the first interposer can directly couple HBM devices 482a, 482b, and 482c of the first SiP device 480 to HBM devices 430a, 430d, and 430g (respectively) of the MiP device 400. The second interposer can directly couple HBM devices 492a, 492b, and 492c of the second SiP device 490 to HBM devices 430c, 430f, and 430i (respectively) of the MiP device 400.

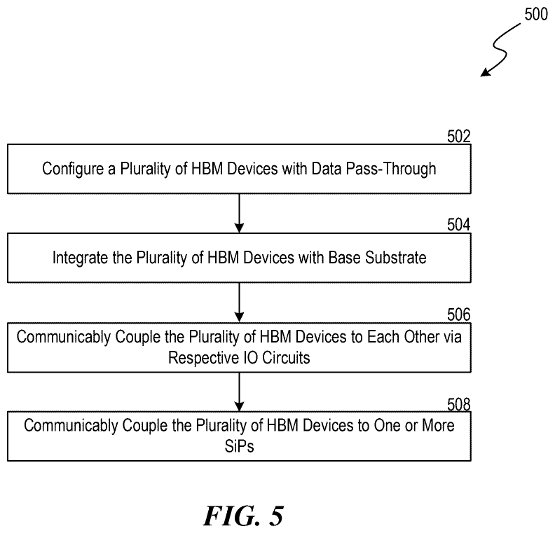

FIG. 5 is a flow diagram of a process 500 for manufacturing a MiP device in accordance with some embodiments of the present technology. The process 500 can be implemented by a single manufacturing apparatus and/or split between multiple manufacturing apparatuses to construct MiP devices according to the embodiments discussed above.

The process 500 begins at block 502 by configuring a plurality of HBM devices with data pass-through. In some embodiments, each of the plurality of HBM devices can include an interface die configured with multiple sets of pass-through logic (e.g., a first and second set of pass-through logic). The interface die is configured to steer and/or direct data along a data pathway via the multiple sets of pass-through logic. The interface die determines the data pathway for a given piece of data based at least in part on an address associated with the data and an address scheme (e.g., a global or local address scheme). In addition to an interface die, each of the HBM devices includes multiple IO circuits (e.g., a first and second IO circuit), multiple pluralities of TSVs (e.g., first and second pluralities of TSVs), and one or more memory die. In some embodiments the memory of one or more of the HBM devices is partitioned to form a first and second memory partition. The first and second memory partitions are communicably coupled to the interface die via the first and second IO circuits and first and second pluralities of TSVs.

At block 504, the plurality of HBM devices are integrated with a base substrate. In various embodiments, the base substrate can be a silicon interposer, a substrate of organic material, a substrate of inorganic material, and/or any other suitable material that provides external connections to each of the plurality of HBM devices and/or provides mechanical support for the components of the plurality of HBM devices. Integrating the plurality of HBM devices with the base substrate can include bonding the HBM devices to the base substrate via one or more interconnect structures (e.g., solder structures, conductive posts, and/or the like) and/or forming one or more metal-metal bonds directly between bond pads in the base substrate and bond pads in each of the plurality of host devices.

At block 506, the process 500 includes communicably coupling the plurality of HBM devices to each other via their respective IO circuits to form a MiP. For example, the second IO circuit of a first HBM device can communicably couple to the first IO circuit of a second HBM device, and the second IO circuit of the second HBM device can communicably couple to the first IO circuit of a third HBM device. As discussed in more detail above, the communicable coupling can be accomplished through one or more communication channels in an upper surface of the base substrate. In some embodiments, the process 500 can execute block 506 before executing all (or some of) block 504 to communicably couple the plurality of HBM devices before integrating the plurality of HBM devices with the base substrate. In some embodiments, the process 500 can execute block 504 at generally the same time as block 506 to integrate the plurality of HBM devices with the base substrate while communicably coupling the HBM devices with each other at generally the same time.

At block 508, the process 500 includes communicably coupling the plurality of interconnected HBM devices (e.g., the MiP) with one or more SiPs. Each of the one or more SiPs can include one or more host devices. The communicable coupling can be accomplished through one or more communication channels in an upper surface of a common base substrate configured to carry the MiP and the SiPs. In some embodiments, the communicable coupling can be accomplished through one or more communication channels in an upper surface of a first base substrate configured to carry a subset of the HBM devices of the MiP and a subset of HBM devices and/or the host device of a first SiP. A second base substrate can be configured to carry a subset of the HBM devices of the MiP and a subset of HBM devices and/or the host device of a second SiP. In some embodiments, the first and second IO circuits of one or more of the plurality of HBM devices conform to the JEDEC HBM DRAM standard. In other embodiments, the first and second IO circuits conform to a short reach interface standard.

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Further, the terms “approximately,” “generally,” and/or “about” are used herein to mean within at least 10% of a given value or limit. Purely by way of example, an approximate ratio means within 10% of the given ratio.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments.

Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

We claim:

1. A memory-in-package (MiP) device, comprising:
a base substrate;
a first high-bandwidth memory (HBM) device carried by the base substrate, wherein the HBM device comprises:
an interface die comprising:
a first input/output (IO) circuit;
a second IO circuit;
a first set of pass-through logic configured to pass data from the first IO circuit to the second IO circuit; and
a second set of pass-through logic configured to pass data from the second IO circuit to the first IO circuit;
one or more volatile memory dies carried by the interface die;
a first plurality of through substrate vias (TSVs) communicably coupled to the interface die, each of the one or more volatile memory dies, and the first IO circuit; and
a second plurality of TSVs communicably coupled to the interface die, each of the one or more volatile memory dies, and the second IO circuit;
a second HBM device carried by the base substrate adjacent to the first HBM device, wherein the first HBM device is communicably coupled to the second HBM device by the first IO circuit; and
a third HBM device carried by the base substrate adjacent to the first HBM device, wherein the first HBM device is communicably coupled to the third HBM device by the second IO circuit;
wherein the first HBM device is configured to pass a data request for the third HBM device, received from the second HBM device by the first IO circuit, to the third HBM device via the first set of pass-through logic and the second IO circuit.

2. The MiP device of claim 1, wherein at least one of the first, second, or third HBM devices is communicably coupled to a host device.

3. The MiP device of claim 1, wherein the interface die is configured to modify an address associated with the data request prior to transmitting the data request to the third HBM device via the second IO circuit.

4. The MiP device of claim 3, wherein the address associated with the data request is modified by reducing the address based on a memory capacity of the first HBM device.

5. The MiP device of claim 1, wherein each of the first, second, and third HBM devices is associated with a respective range of addresses that form a global address scheme, and wherein the interface die is configured to pass data requests received at the first IO circuit to the second IO circuit or the first plurality of TSVs based on the address associated with each data request.

6. The MiP device of claim 5, wherein the interface die is further configured to:
pass data requests received at the first IO circuit to the first plurality of TSVs when the address associated with the data request is within a range of addresses associated with the first HBM device; and
pass data requests received at the first IO circuit to the second IO circuit when the address associated with the data request is not within a range of addresses associated with the first HBM device.

7. The MiP device of claim 1, wherein each volatile memory die of the one or more volatile memory dies comprises a first memory partition and a second memory partition, wherein the first memory partition of the one or more memory dies is coupled to the first plurality of TSVs, and the second memory partition of the one or more memory dies is coupled to the second plurality of TSVs.

8. The MiP device of claim 7, wherein the first memory partition is associated with a first set of memory banks and the second memory partition is associated with a second set of memory banks.

9. The MiP device of claim 7, wherein the first memory partition is associated with a first plurality of bank groups, and the second memory partition is associated with a second plurality of bank groups.

10. The MiP device of claim 7, wherein the first memory partition is associated with a first pseudo channel, and the second memory partition is associated with a second pseudo channel.

11. The MiP device of claim 1, wherein at least one of the first IO circuit or the second IO circuit is configured to operate in accordance with a JEDEC HBM DRAM standard.

12. The MiP device of claim 1, wherein at least one of the first IO circuit or the second IO circuit is configured to operate in accordance with a short reach interface standard.

13. A high-bandwidth memory (HBM) device with data pass-through, the HBM device comprising:
an interface die comprising:
a first input/output (IO) circuit;
a second IO circuit;
a first set of pass-through logic configured to pass data from the first IO circuit to the second IO circuit; and
a second set of pass-through logic configured to pass data from the second IO circuit to the first IO circuit;
one or more volatile memory dies carried by the interface die;
a first plurality of through substrate vias (TSVs) communicably coupled to the interface die, each of the one or more volatile memory dies, and the first IO circuit; and
a second plurality of TSVs communicably coupled to the interface die, each of the one or more volatile memory dies, and the second IO circuit;
wherein the HBM device is configured to pass a data request from a second HBM device to a third HBM device, and wherein the HBM device receives the data request by the first IO circuit and passes the data request to the second HBM device via the first set of pass-through logic and the second IO circuit.

14. The HBM device of claim 13, wherein at least one of the HBM device, the second HBM device, or the third HBM device is communicably coupled to a host device.

15. The HBM device of claim 13, wherein the interface die is configured to modify an address associated with the data request prior to transmitting the data request to the third HBM device via the second IO circuit.

16. The HBM device of claim 13, wherein the HBM device is associated with a range of addresses, the range of addresses representing a subset of a global addresses range, and wherein the interface die is configured to pass data requests received at the first IO circuit to the second IO circuit or the first plurality of TSVs based on the address associated with each data request.

17. The HBM device of claim 13, wherein each volatile memory die of the one or more volatile memory dies comprises a first memory partition and a second memory partition, wherein the first memory partition of the one or more memory dies is coupled to the first plurality of TSVs, and the second memory partition of the one or more memory dies is coupled to the second plurality of TSVs.

18. The HBM device of claim 17, wherein the first memory partition is associated with a first set of memory banks and the second memory partition is associated with a second set of memory banks.

19. The HBM device of claim 17, wherein the first memory partition is associated with a first plurality of bank groups, and the second memory partition is associated with a second plurality of bank groups.

20. The HBM device of claim 17, wherein the first memory partition is associated with a first pseudo channel, and the second memory partition is associated with a second pseudo channel.
